(19) United States
(12) Patent Application Publication
(10) Pub. No.: US 2025/0343381 A1
(43) Pub. Date: Nov. 6, 2025

(54) ATTACHABLE HOUSING FOR MOUNTING ON A WALL HAVING AN OPENING

(71) Applicant: Phoenix Contact GmbH & Co. KG, Blomberg (DE)

(72) Inventor: Manuel TÜNKER, Dörentrup (DE)

(21) Appl. No.: 19/190,814

(22) Filed: Apr. 28, 2025

(30) Foreign Application Priority Data
May 2, 2024 (BE) BE2024/5256

(51) Int. Cl. H01R 13/74; H01R 13/52; H01R 13/627

(52) U.S. Cl. CPC H01R 13/743; H01R 13/5202; H01R 13/6273

(57) ABSTRACT

An attachable housing for mounting on a wall having an opening, for receiving at least one contact insert, includes: two opposite longitudinal sides and two opposite end faces, which together enclose a receiving region for the at least one contact insert, the receiving region being open both to a connection side and to an opposite plug-in side, and having a circumferential flange section which, in a mounted state of the attachable housing, lies against the wall. At least one first latching element for latching with a corresponding first mating latching element of the at least one contact insert and at least one second latching element for latching with a corresponding second mating latching element of the at least one contact insert are arranged on a longitudinal side and/or an end face of the attachable housing. The at least one first latching element fixes the at least one contact insert.

### CROSS-REFERENCE TO PRIOR APPLICATION

Priority is claimed to Belgian Patent Application No. BE2024/5256, filed on May 2, 2024, the entire disclosure of which is hereby incorporated by reference herein.

### FIELD

The invention relates to an attachable housing for mounting on a wall having an opening, in particular a device wall or housing wall, and for receiving at least one contact insert, with two opposite longitudinal sides and two opposite end faces, which together enclose a receiving region for a contact insert, wherein the receiving region is open both to the connection side and to the opposite plug-in side and has a circumferential flange section which, in the mounted state of the attachable housing, lies against the outside of the wall.

### BACKGROUND

Furthermore, the invention also relates to an assembly comprising a corresponding attachable housing and a contact insert, wherein the contact insert has an insulating body in which a plurality of contact elements are arranged, wherein the insulating body has two mutually opposite longitudinal sides and two mutually opposite end faces.

Contact inserts for plug connectors, in which a plurality of contact elements are arranged, serve to be connected to a corresponding mating contact insert which is arranged in a housing of a mating connector. The contact elements may in particular be contact pins or contact sockets which are connected to corresponding contact elements of the mating contact insert when the contact insert is plugged together with a corresponding mating contact insert, or the connector is plugged together with the corresponding mating connector.

Attachable housings serve to accommodate contact inserts that are to be mounted on a wall, in particular a device wall or housing wall, for example a switch cabinet wall. For this purpose, an opening is formed in the wall into which the contact insert can be inserted with the aid of the attachable housing by fastening the attachable housing, enclosing the opening, to the wall and fastening the contact insert in the attachable housing. The contact elements of the contact insert are connected on the connection side to corresponding cables or a corresponding plug, while the contact insert on the plug-in side can be connected to a corresponding mating contact insert arranged in a housing of a mating connector. The connection side corresponds to the inside and the plug-in side to the outside of the device, housing, or switch cabinet.

In practice, such an attachable housing is usually fastened to the wall using screws that are screwed into corresponding holes in the wall. Depending on the type of attachable housing, it can be inserted into the opening in the housing wall either from the outside or from the inside before being screwed to the housing wall. This allows a mechanically strong and reliable connection of the attachable housing to the wall to be achieved. However, it is disadvantageous that the mounting process is relatively complex and the associated mounting time is relatively long.

From DE 10 2010 017 361 A1, an attachable connector is known consisting of an attachable housing and a contact carrier arranged in the attachable housing, which can be fixed to the wall via two resilient latching elements arranged on the end faces of the attachable housing. The attachable housing has a circumferential flange as an insertable stop, so that the attachable connector is fastened to the wall by the latching elements extending through the opening in the wall and engaging behind the edge of the opening on the inside when the flange lies against the outside of the wall. Since the known attachable connector is a pre-assembled attachable connector, it is not possible to replace or subsequently install the contact carrier in the wall-mounted attachable housing.

### SUMMARY

In an embodiment, the present invention provides an attachable housing for mounting on a wall having an opening, for receiving at least one contact insert, comprising: two opposite longitudinal sides and two opposite end faces, which together enclose a receiving region for the at least one contact insert, the receiving region being open both to a connection side and to an opposite plug-in side, and having a circumferential flange section which, in a mounted state of the attachable housing, lies against the wall, wherein at least one first latching element configured to latch with a corresponding first mating latching element of the at least one contact insert and at least one second latching element configured to latch with a corresponding second mating latching element of the at least one contact insert are arranged on a longitudinal side and/or an end face of the attachable housing, wherein the at least one first latching element is configured to fix the at least one contact insert inserted into the attachable housing from the connection side, and wherein the at least one second latching element is configured to fix the at least one contact insert inserted into the attachable housing from the plug-in side.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a perspective view of an exemplary embodiment of an attachable housing;

FIGS. 2a and 2b show the attachable housing according to FIG. 1, inserted into an opening in a wall, in perspective view, from the connection side, and in longitudinal section,

FIG. 3 shows the attachable housing with a contact insert to be inserted from the connection side, in perspective view,

FIG. 4 shows the attachable housing with a contact insert to be inserted from the plug-in side, in perspective view,

FIGS. 5a and 5b show the attachable housing with inserted contact insert, in longitudinal section and in cross section,

FIGS. 6a and 6b show the attachable housing with inserted contact insert, in perspective view from the connection side and from the plug-in side, and

FIG. 7 shows a perspective view of an attachable housing inserted into an opening in a wall with a mating connector fastened to the attachable housing.

### DETAILED DESCRIPTION

In an embodiment, the present invention provides an attachable housing that enables a contact insert to be mounted simply and flexibly. The contact insert should preferably be mounted without tools. In addition, an assembly consisting of a corresponding attachable housing and a contact insert is provided in which the mechanical connection of the attachable housing and the contact insert can be made simply.

In an embodiment, the present invention provides an attachable housing, in which at least one first latching element for latching with a corresponding first mating latching element of a contact insert and at least one second latching element for latching with a corresponding second mating latching element of a contact insert are arranged on a longitudinal side and/or an end face of the attachable housing. The at least one first latching element is designed to fix a contact insert inserted from the connection side into the receiving region of the attachable housing, while the at least one second latching element is designed to fix a contact insert inserted from the plug-in side into the receiving region of the attachable housing. Accordingly, the first latching element and the second latching element are each arranged on the inner side, facing the receiving region, of a longitudinal side and/or on an end face of the attachable housing.

By forming at least one first latching element and at least one second latching element, which each interact with corresponding mating latching elements of the contact insert, a simple, in particular tool-free, fastening of the contact insert in the attachable housing is possible. In addition, due to the different design of the first latching element and the second latching element, it is possible to mount a contact insert in the attachable housing both from the connection side and from the plug-in side, i.e., from both the inside and the outside of the device wall or housing wall.

Preferably, both two first latching elements and two second latching elements are formed on the attachable housing, thereby ensuring secure fixing of a contact insert in the attachable housing. In addition, the two first latching elements and the two second latching elements are preferably formed on opposite sides of the attachable housing, for example the two first latching elements on the two longitudinal sides and the two second latching elements on the two end faces. In the following, it is generally assumed that two first latching elements and two second latching elements are formed on the attachable housing, even if the invention is not limited to this. In addition to the possibility that only one first latching element or only one second latching element is provided, more than two first latching elements and two second latching elements can also be formed on the attachable housing.

According to a further advantageous embodiment, the at least one first latching element has a stop for a contact insert inserted into the attachable housing from the plug-in side. Accordingly, the at least one second latching element preferably also has a stop for a contact insert inserted into the attachable housing from the connection side. The first and second latching elements therefore each have a different function, depending on whether a contact insert is inserted into the attachable housing from the connection side or from the plug-in side.

If a contact insert is inserted into the attachable housing from the connection side, the second latching elements serve as a stop when inserting the contact insert, while the first latching elements, together with the corresponding first mating latching elements on the contact insert, serve to latch the inserted contact insert so that the contact insert cannot be pulled out of the attachable housing from the connection side in the direction opposite the insertion direction. If, however, a contact insert is inserted into the attachable housing from the plug-in side, the first latching elements serve as a stop when inserting the contact insert, while the second latching elements, together with the corresponding second mating latching elements on the contact insert, serve to latch the inserted contact insert so that the contact insert cannot be pulled out of the attachable housing from the plug-in side in the direction opposite the insertion direction.

When inserting a contact insert from the connection side, the first latching elements thus serve to fix the contact insert, while when inserting a contact insert from the plug-in side, the first latching elements serve as a stop for the contact insert. Accordingly, the second latching elements serve to fix the contact insert when inserting a contact insert from the plug-in side, while the second latching elements serve as a stop for the contact insert when inserting a contact insert from the connection side.

There are various options regarding the specific embodiment of the first and second latching elements. According to a preferred embodiment, the first latching elements are each formed as a resilient latching arm which has a base region and a latching lug, wherein the base region is connected to a longitudinal side or an end face of the attachable housing. The latching arms are arranged in such a way that the latching lug is at a smaller distance from the flange section than the base region is. The extent of the latching arm from the base region to the latching lug then runs opposite to the insertion direction of a contact insert from the connection side into the attachable housing. When a contact insert is inserted from the connection side into the attachable housing, the contact insert first slides along the latching lug with its first mating latching element before the latching lug latches with the mating latching element.

If the first latching elements are formed as resilient latching arms, the rear side of the latching lug, which rear side runs substantially perpendicular to the longitudinal extent of the latching arm, is preferably formed as a stop for a contact insert inserted into the attachable housing from the plug-in side. The rear side of the latching lug thus serves on the one hand to latch with a corresponding mating latching element of a contact insert inserted from the connection side and on the other hand as a stop when inserting the contact insert from the plug-in side. The position of the rear side of the latching lug determines how deeply the contact insert can be inserted from the plug-in side into the receiving region of the attachable housing.

According to another preferred embodiment, the first latching elements are each formed as a resilient latching tab having a base region and a free end, wherein the base region is connected to a longitudinal side or an end face of the attachable housing. The latching tab is arranged such that the base region has a smaller distance from the flange section than the free end of the latching tab does. The extent of the latching tab from the base region to the free end then runs in the insertion direction of a contact insert from the connection side into the attachable housing. In this embodiment of the first latching element, the extent is thus opposite to the extent of a latching element formed as a resilient latching arm.

If the first latching elements are formed as latching tabs, the free end of the latching tab is formed as a stop for a contact insert inserted into the attachable housing from the plug-in side. In this embodiment, the free end of the latching tab serves on the one hand to latch with a corresponding mating latching element of a contact insert inserted from the connection side and on the other hand as a stop when inserting the contact insert from the plug-in side. The position of the free end of the latching tab then determines how deeply the contact insert can be inserted from the plug-in side into the receiving region of the attachable housing.

Regardless of whether the first latching elements are formed as a resilient latching arm or as a resilient latching tab, the latching elements can easily perform both the function of latching when inserting a contact insert from the connection side and the function of a stop when inserting a contact insert from the plug-in side, without the latching elements having a shape that is complex to manufacture.

According to an advantageous embodiment, the second latching elements are each formed as a recess in a longitudinal side or an end face of the attachable housing, wherein the recess has at least one edge running substantially perpendicular to the insertion direction of a contact insert, which edge is formed as a latching edge for a corresponding second mating latching element of a contact insert. If two second latching elements are formed on the attachable housing, a corresponding recess is preferably formed in each of the two opposite end faces or in the two opposite longitudinal sides.

The design of the second latching elements as a recess with an edge has the advantage that the edge of the recess can also be formed as a stop for a contact insert inserted into the attachable housing from the connection side. The second latching elements can therefore also easily perform both the function of latching when inserting a contact insert from the plug-in side and the function of a stop when inserting a contact insert from the connection side.

The fastening of the attachable housing to a wall can generally be done, as is known from practice, with screws that are screwed through openings in the flange of the attachable housing into corresponding holes in the wall. However, according to a preferred embodiment, the attachable housing has at least two fastening elements for fixing the attachable housing to the wall, wherein the fastening elements extend beyond the flange section.

According to a preferred embodiment, the fastening elements are formed as latching tabs, so that tool-free fastening of the attachable housing to the wall or in the opening of the wall is possible by inserting the latching tabs into the opening and engaging behind the edge of the opening. The latching tabs preferably each have an actuating portion in order to be able to move the latching tab from a first position into a second position, wherein the attachable housing is locked in the opening in the first position and in the second position the locking is released and the attachable housing can be removed from the opening.

With regard to the fastening elements formed as latching tabs, it has been stated above that these can be moved from a first position to a second position. If the attachable housing is inserted into the opening in the wall, the attachable housing can be locked in the opening by pivoting each of the latching tabs into the first position, or by their being in the first position. A pivotable arrangement of a latching tab on the attachable housing can be realized in that the latching tab is arranged pivotably about a bearing pin extending transversely to the insertion direction on an end face or a longitudinal side of the attachable housing.

According to a preferred embodiment, the latching tabs are formed in one piece with the corresponding end face or longitudinal side of the attachable housing, wherein the latching tabs are formed as resilient latching tabs, the base region of each of which is connected to one side of the attachable housing and the free end of which has at least one latching lug. The resilient latching tabs are each arranged on one side of the attachable housing in such a way that when the attachable housing is inserted into the opening they are first deflected in the direction of the receiving region and then spring back into their first position when the attachable housing has reached its defined end position, i.e., when the flange section lies against the outside of the wall. The latching lugs of the latching tabs then engage behind the edge of the opening, whereby the attachable housing is securely latched in the opening in the wall. The latching tabs then do not have to be actively moved into their first position by the user, so that the latching occurs automatically when the attachable housing is inserted into the opening in the wall.

By means of the actuating portion preferably formed on the latching tabs, which can be, for example, a recess for inserting a tool, the latching tab can be moved from the first position to a second position when the attachable housing is to be removed from the opening in the wall. The latching tabs or their latching lugs can be formed in such a way that the latching tab cannot be unlocked when a contact insert is inserted into the attachable housing. For this purpose, a projection can be formed on the rear side of the latching lug, which interacts with the opposite end face of an inserted contact insert, so that when the contact insert is inserted the latching tab cannot be deflected so far that the latching lug comes out of engagement with the edge of the opening.

According to a further preferred embodiment, a groove is formed in the flange section, in which groove a seal is arranged by which the attachable housing is sealed against the wall in the mounted state. The groove is formed in such a way that the seal is compressed by a defined amount in the mounted state, because the depth of the groove is smaller than the corresponding thickness of the seal. At the same time, the defined depth of the groove ensures that the seal is not compressed too much, thus preventing damage to the seal. In addition, the outer wall of the groove also protects the seal accommodated in the groove from external influences, so that a relatively soft seal can be used.

In order to facilitate the insertion of a contact insert into the attachable housing, guide ribs or guide grooves projecting into the receiving region can be formed on the longitudinal sides or on the end faces of the attachable housing for engagement with corresponding grooves or ribs of a contact insert.

The above-mentioned object is achieved in an assembly comprising an attachable housing according to the invention and at least one contact insert as described herein. At least one first mating latching element for latching with the corresponding first latching element of the attachable housing and at least one second mating latching element for latching with the corresponding second latching element of the attachable housing are formed on the insulating body of the contact insert. The at least one first mating latching element latches with the first latching element when the contact insert is inserted into the attachable housing from the connection side, while the at least one second mating latching element latches with the first latching element of the attachable housing when the contact insert is inserted into the attachable housing from the plug-in side.

As previously explained in connection with the attachable housing according to the invention, the assembly also has the feature that the formation of at least one first mating latching element and at least one second mating latching element, which each interact with corresponding latching elements of the attachable housing, enables simple, in particular tool-free, fastening of the contact insert in the attachable housing. In addition, the different design of the first mating latching element and the second mating latching element makes it possible to mount a contact insert in the attachable housing from both the connection side and the plug-in side.

If two first latching elements and two second latching elements are formed on the attachable housing, the contact insert also has two first mating latching elements and two second mating latching elements, which are preferably each formed on opposite sides of the insulating body, for example the two first mating latching elements on the two longitudinal sides and the two second mating latching elements on the two end faces of the insulating body.

If the at least one first latching element of the attachable housing is formed as a latching arm or as a latching tab, the at least one first mating latching element of the contact insert is preferably formed as a shoulder on the insulating body. If the contact insert is fully inserted into the attachable housing from the connection side, the latching lug of the latching arm or the free end of the latching tab latches with the shoulder on the insulating body, thereby fixing the contact insert in the attachable housing. Preferably, the shoulder is formed and arranged on the insulating body in such a way that it lies against a stop formed on the latching arm, in particular the rear side of the latching lug, when the contact insert is inserted into the attachable housing from the plug-in side.

If the at least one second latching element of the attachable housing is formed as a recess, the at least one second mating latching element is formed on the side of the insulating body. If, for example, the attachable housing has a recess on each of its two end faces, a latching element is formed correspondingly on each of the two end faces of the insulating body of the contact insert. Preferably, the latching element is formed such that a portion of the latching element lies against a stop of the second latching element of the attachable housing when the contact insert is inserted into the attachable housing from the connection side.

Preferably, the latching elements of the contact insert are then each formed as a resilient latching arm which has a base region and at least one latching lug, wherein the base region is connected to the insulating body. The resilient latching arms are arranged on the end face or the longitudinal side of the insulating body in such a way that when the contact insert is inserted into the attachable housing they are first deflected to the corresponding side and then spring back to their first position when the contact insert has reached its defined end position. The latching lugs of the latching arms then engage in the corresponding recesses in the opposite sides of the attachable housing, whereby the contact insert is securely latched in the attachable housing.

If a contact insert is to be removed from the attachable housing again, the latching elements must be moved from their first position to their second position, the removal position. In the second position, the latching lugs of the latching elements do not engage in the recesses in the attachable housing, so that the contact insert can be easily removed from the attachable housing. In order to make the removal of the contact insert from the attachable housing as easy as possible, the latching elements preferably each have an actuating portion in order to move the latching element from the first position to the second position. Preferably, the actuating portion is designed as a holder for a tool, for example the tip of a screwdriver. The latching element can then be easily pivoted from the first position to the second position by inserting the tip of the tool into the holder and then pivoting the tool. The shape of the holder can be used to determine whether the latching element can be pivoted with a conventional screwdriver or only with a special tool.

According to a preferred embodiment of the contact insert, in which the latching elements are formed as resilient latching arms, the latching arms each have two latching lugs which are slightly spaced apart from one another. The actuating portion formed as a holder for a tool is formed between the two latching lugs, so that the latching lugs also serve as a guide for the tip of the tool when inserting the tool into the holder.

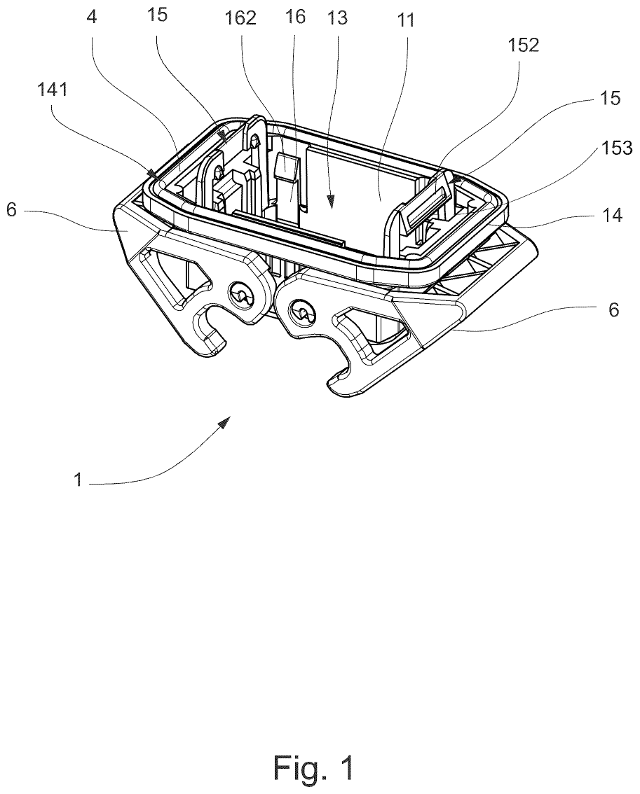

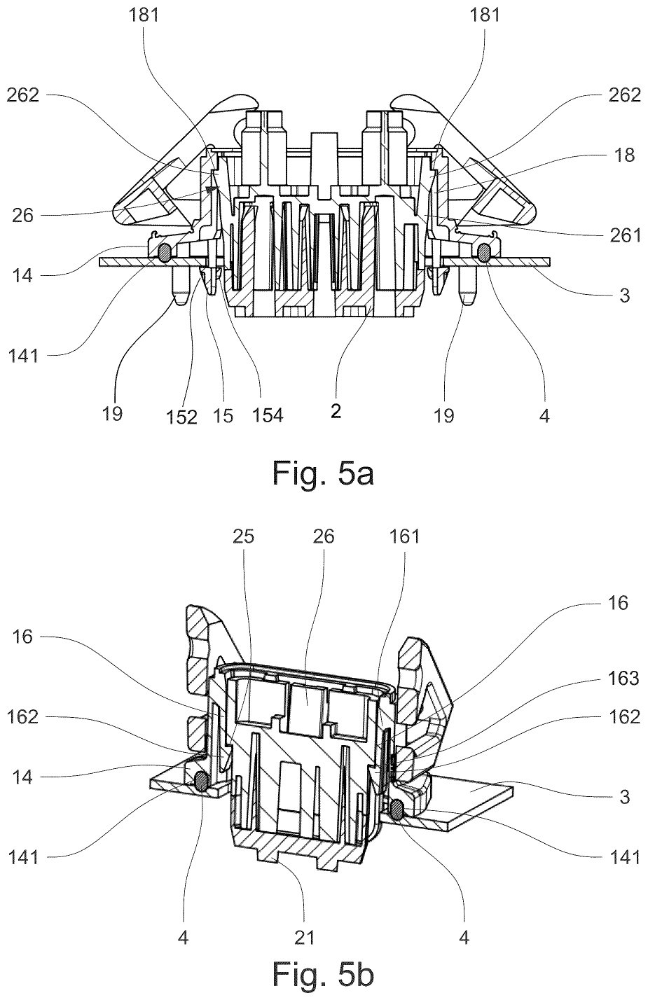

FIG. 1 shows a perspective view of an attachable housing 1 which is intended for mounting on a wall 30 having an opening 31, for example a switch cabinet wall or device wall. The attachable housing 1 also serves to accommodate a contact insert 2 so that the contact insert 2 can be fastened in the opening 31 of the wall 3 using the attachable housing 1. An attachable housing 1 mounted in an opening 31 of a wall 3 and receiving a contact insert 2 is shown in FIGS. 5a and 5b from two different perspectives.

The attachable housing 1 has two opposite longitudinal sides 11 and two likewise opposite end faces 12, which together enclose a receiving region 13 for a contact insert 2. In the illustrated embodiments, the receiving region 13 of the attachable housing 1 is rectangular, wherein a fixed-pole contact insert 2 with external dimensions corresponding to the receiving region 13 can be inserted into the receiving region 13. Alternatively, the dimensions of the attachable housing 1 or the contact insert 2 can also be formed such that a plurality of contact inserts can be inserted into the receiving region 13 of the attachable housing 1. The dimensions of the attachable housing 1 and the contact insert 2 may therefore differ from the dimensions shown in the exemplary embodiments. For example, the extent of the longitudinal sides 11 of the attachable housing 1 can be shorter and the extent of the end faces 12 longer than in the illustrated embodiment. It is also possible for the length of the end faces 12 to correspond to or even exceed the length of the longitudinal sides 11.

In addition to the longitudinal sides 11 and the end faces 12, the attachable housing 1 has a circumferential flange section 14 which, when the attachable housing 1 is in the mounted state, lies against one side of the wall 3. In the illustrated embodiments, the attachable housing 1 is designed such that in the mounted state of the attachable housing 1 the flange section 14 lies against the outside of the wall 3. The outer side of the wall 3 or of a housing or switch cabinet delimited by the wall corresponds to the plug-in side S and the opposite inner side of the wall 3 corresponds to the connection side A of the attachable housing 1 or of a contact insert 2 received in the attachable housing 1.

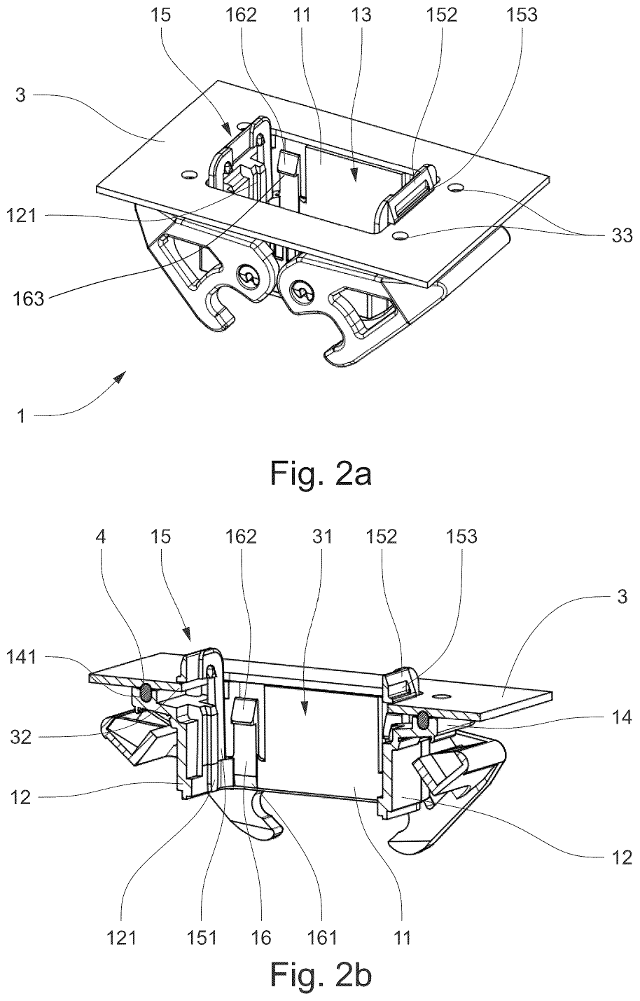

As can be seen from the two illustrations according to FIGS. 2a and 2b, for fastening the attachable housing 1 in the opening 31 of a wall 3, a fastening element is arranged on each of the two end faces 12 of the attachable housing 1, which fastening element is formed as a latching tab 15. The latching tabs 15 each have a base region 151 which is connected to an end face 12 of the attachable housing 1. At the free end of each of the latching tabs 15, which extend beyond the flange section 14, a latching lug 152 is formed by which the attachable housing 1 is fixed in the opening 31 in the wall 3. When inserting the attachable housing 1 from the plug-in side S into the opening 31 in the wall 3, the latching tabs 15 are initially deflected inward in the direction of the receiving region 13. If the attachable housing 1 is inserted into the opening 31 so far that the flange section 14 lies against the outside of the wall 3, the latching tabs 15 spring back into their first position, the locking position, and the latching lugs 52 of the latching tabs 15 engage behind the edge 32 of the opening 31, whereby the attachable housing 1 is securely latched in the opening 31 in the wall 3.

Since the latching lugs 152 of the latching tabs 15 have corresponding bevels, the previously described deflection of the latching tabs 15 occurs automatically when the attachable housing 1 is inserted into the opening 31. Due to the resilient properties of the latching tabs 15, they do not have to be actively moved into their first position by a user, so that the latching of the attachable housing 1 in the opening 31 in the wall 3 occurs automatically when it is inserted into the opening 31.

In order to be able to remove the attachable housing 1 from the opening 31 of the wall 3 again if necessary, the latching tabs 15 each have an actuating portion 153, which in the illustrated embodiment is formed as a recess in the region of the latching lug 152. The tip of a screwdriver, for example, can then be inserted from the connection side A into the actuating portion 153 or the recess in the latching lug 152, whereby the corresponding latching tab 15 is deflected and the latching of the latching lug 152 with the edge 32 of the opening 31 can be released.

As can be seen from the sectional view according to FIG. 5a, a projection 154 is formed on the rear side of the latching lug 152, which projection interacts with the opposite end face 24 of the inserted contact insert 2, so that when the contact insert 2 is inserted the latching tab 15 cannot be deflected so far that the latching lug 152 comes out of engagement with the edge 32 of the opening 31.

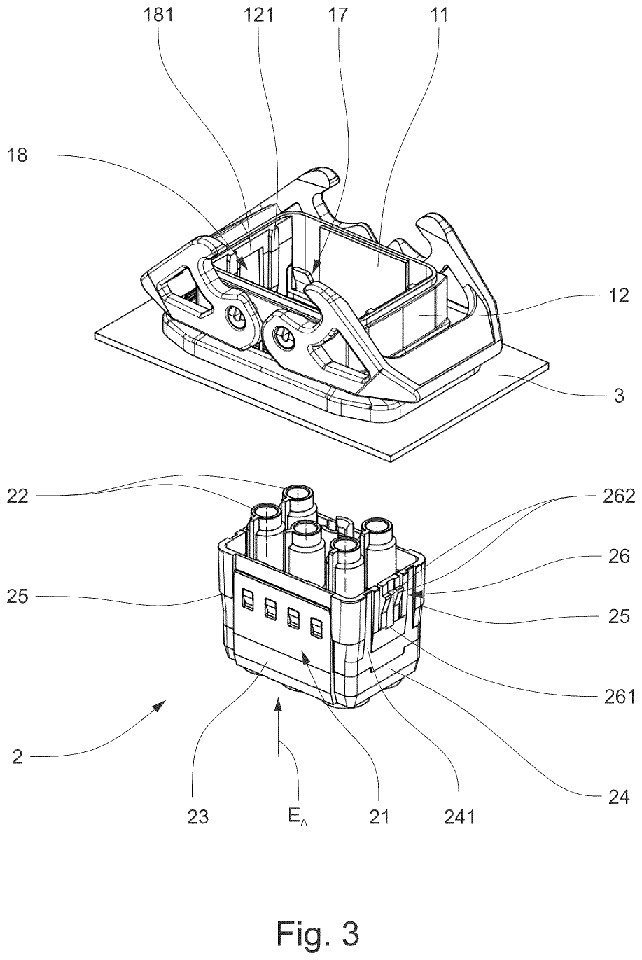

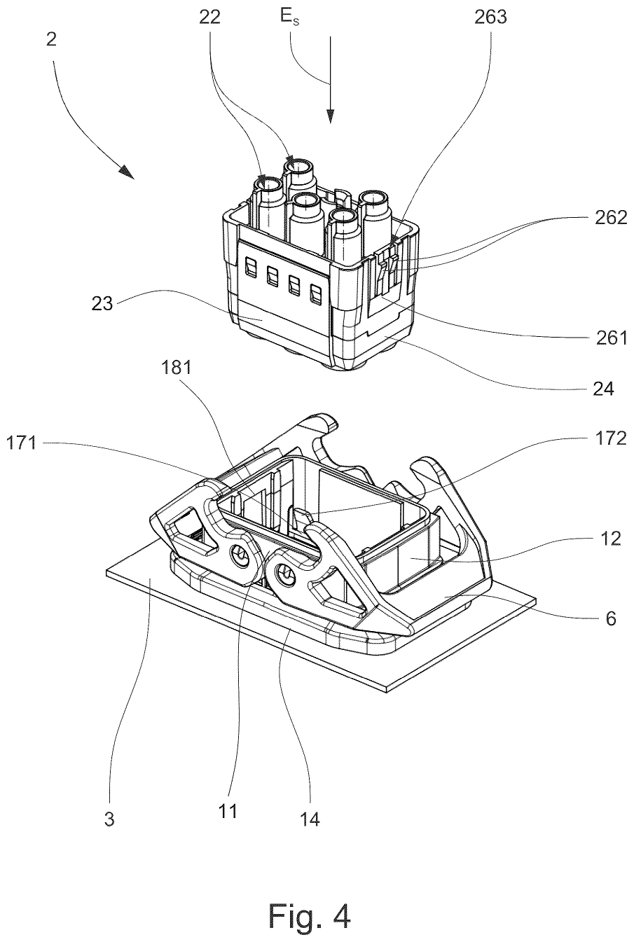

FIG. 3 shows an attachable housing 1 inserted in the opening 31 in a wall 3 with a contact insert 2 on the connection side A, while FIG. 4 shows the attachable housing 1 with the same contact insert 2, now however arranged on the plug-in side S. The contact insert 2 has an insulating body 21 in which a plurality of contact elements 22 are arranged, which can in particular be contact pins or contact sockets. The insulating body 21 has two opposite longitudinal sides 23 and two likewise opposite end faces 24, wherein the insulating body 21 has a rectangular cross section whose dimensions are adapted to the dimensions of the receiving region 13 of the attachable housing 1.

In order to fix a contact insert 2 inserted into the receiving region 13 of the attachable housing 1, first latching elements 16, 17 are arranged on the two longitudinal sides 11 of the attachable housing 1 and at least one second latching element 18 is arranged on the end faces 12. The first latching elements serve to latch with corresponding first mating latching elements and the second latching elements serve to latch with corresponding second mating latching elements on the contact insert 2. The design of the first latching elements and the second latching elements enables a simple and tool-free fastening of a contact insert 2 in the attachable housing 1. In addition, the different design of the first latching elements and the second latching elements also enables the mounting of a contact insert 2 into the attachable housing 1 both from the connection side A and from the plug-in side S. This is explained below with reference to FIGS. 3 and 4.

If the contact insert 2 is inserted into the attachable housing 1 from the connection side A in the insertion direction EA as shown in FIG. 3, the first latching elements on the longitudinal sides 11 together with the corresponding first mating latching elements on the contact insert 2 serve to latch the inserted contact insert 2, so that the contact insert 2 cannot be pulled out of the attachable housing 1 again from the connection side A against the insertion direction EA.

However, if the contact insert 2 is inserted into the attachable housing 2 from the insertion direction S in the insertion direction ES as shown in FIG. 4, the second latching elements on the end faces 12 of the attachable housing 1 together with the corresponding second mating latching elements on the end faces 24 of the contact insert 2 serve to latch the inserted contact insert 2, so that the contact insert 2 cannot be pulled out of the attachable housing 1 again from the plug-in side S against the insertion direction ES.

In the embodiment according to FIGS. 3 and 4, the first latching elements are formed as resilient latching tabs 17 which have a base region 71 and a free end 172, wherein the base region 171 is connected to a longitudinal side 11 of the attachable housing 1. The latching tab 17 is arranged such that the base region 171 has a smaller distance from the flange section 14 than the free end 172 of the latching tab 17 does. The extent of the latching tab 17 from the base region 171 to the free end 172 thus runs in the insertion direction EA of a contact insert 2 from the connection side A. If a contact insert 2 is inserted into the attachable housing 1 from the connection side A according to FIG. 3, the free end 172 of the latching tab 17 is first deflected slightly in the direction of the associated longitudinal side 11 by the insertion of the contact insert 2, before the free end 172 of the latching tab 17 engages under the first mating latching element on the contact insert 2, which is formed as a shoulder 25 on the insulating body 21.

If, in this embodiment of the attachable housing 1, the contact insert 2 is inserted into the receiving region 13 of the attachable housing 1 from the plug-in side S in the insertion direction ES as shown in FIG. 4, then the second mating latching elements formed as latching arms 26 on the end faces 24 of the insulating body 21 latch with recesses 18 which are formed as second latching elements in the end faces 12 of the attachable housing 1. The free ends 172 of the latching tabs 17 serve as a stop when inserting the contact insert 2 in the insertion direction ES, wherein in the mounted state the shoulders 25 formed on the contact insert 2 lie on the free ends 172 of the latching tabs 17.

The contact insert 2 has a total of four shoulders 25 arranged in the region of the corners between the longitudinal sides 23 and the end faces 24 as first mating latching elements and two latching arms 26 arranged on the end faces 24 as second mating latching elements. Both the shoulders 25 and the latching arms 26 are formed in one piece with the insulating body 21. The latching arms 26 each have a base region 261 connected to an end face 24 and two latching lugs 262 at the free end. The extent of the latching arms 26 from the base region 261 to the latching lugs 262 is opposite to the insertion direction ES from the plug-in side S into the receiving region 13 of the attachable housing 1.

In order to be able to remove a contact insert 2 inserted and latched in the attachable housing 1 from the attachable housing 1 again as necessary, the two latching arms 26 each have an actuating portion 263 which is formed as a holder for a tool. If the tip of a tool is inserted into the actuating portion 263, the latching arm 26 can simply be pivoted from its latching position into a second position in which the latching lugs 262 no longer engage with the recess 18 in the end face 12 of the attachable housing 2, so that the contact insert 2 can then be removed from the attachable housing 2.

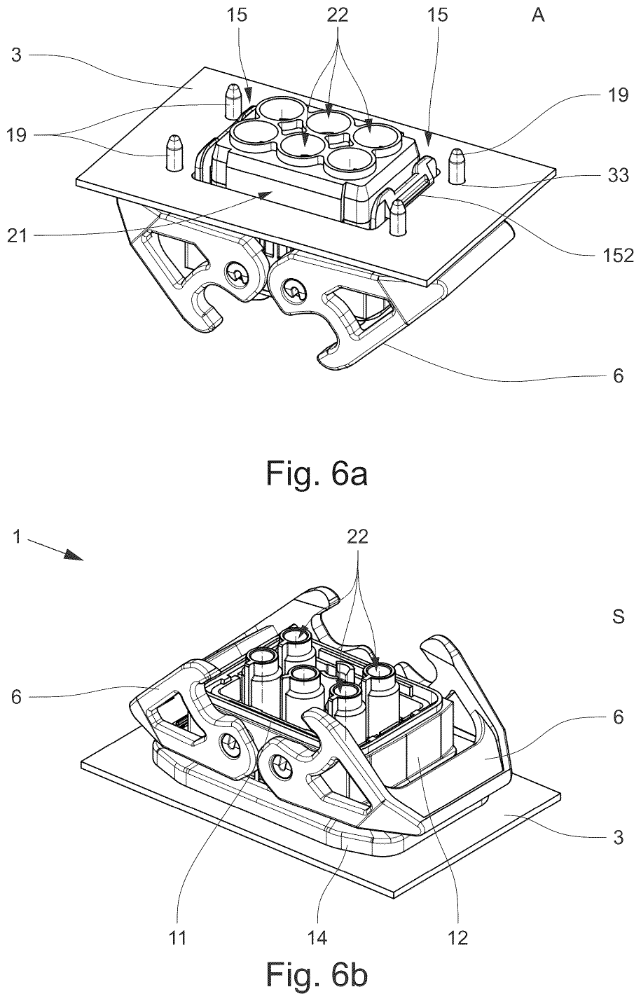

A slightly different design of an attachable housing 1 is shown in FIGS. 2 and 6. The attachable housing 1 shown in FIGS. 2 and 5 differs from the attachable housing 1 previously described and shown in FIGS. 3 and 4 by a slightly different design of the first latching elements.

In the embodiment of the attachable housing 1 according to FIG. 2, the first latching element is formed as a resilient latching arm 16 which has a base region 161 and a latching lug 162. The base region 161 of the latching arm 16 is connected to a longitudinal side 11 of the attachable housing 1, wherein the latching arm 16 is arranged such that the latching lug 162 has a smaller distance from the flange section 14 than the base region 161. The longitudinal extent of the latching arm 16 thus runs, as does the longitudinal extent of the latching tab 17, substantially parallel to the insertion direction EA of a contact insert 2 from the connection side A. If a contact insert 2 is inserted from the connection side A into the receiving region 13 of the attachable housing 1, the extent of the latching arm 16 from the base region 161 to the latching lug 162 is opposite the insertion direction EA of the contact insert 2. When the contact insert 2 is inserted from the connection side A into the attachable housing 1, the contact insert 1 initially slides with its shoulders 25 along the latching lugs 162 before the latching lugs 162 each engage with a shoulder 25. The rear side 163 of the latching lug 162 engages behind the first mating latching element formed as a shoulder 25 on the insulating body 21 of the contact insert 2.

If, however, a contact insert 2 is inserted into the receiving region 13 of the attachable housing 1 from the plug-in side S in the insertion direction ES, the second mating latching elements formed as latching arms 26 on the end faces 24 of the contact insert 2 latch with corresponding recesses 18 which are formed as a second latching element in the end faces 12 of the attachable housing 1. The recesses 18 each have an edge 181 extending substantially perpendicular to the insertion direction ES of a contact insert 2, which edge serves as a latching edge for the latching lugs 262 of the latching arm 26. When inserting a contact insert 2 from the connection side A into the receiving region 13 of the attachable housing 1, the edge 181 of the recess 18 acts as a stop when inserting the contact insert 2, which determines the maximum insertion depth.

The interaction between the latching elements of the attachable housing 1 and the mating latching elements of the contact insert 2 can be seen from the two sectional views according to FIGS. 5a and 5b. From FIG. 5a, it can be seen how the resilient latching arms 26 formed on the two end faces 24 of the insulating body 21 each engage with their latching lugs 262 with the edge 181 of the recess 18 in the end faces 12 of the attachable housing 1, so that a contact insert 2 inserted from the plug-in side S in the insertion direction ES cannot be pulled out of the add-on housing 1 again in the direction of the plug-in side S. From FIG. 5b, it can be seen how the resilient latching arms 16 formed on the two longitudinal sides 11 of the attachable housing 1 each engage with their latching lugs 162 with a shoulder 25 on the insulating body 21 of the contact insert 2, so that the contact insert 2 inserted from the connection side A in the insertion direction EA cannot be pulled out of the attachable housing 1 again in the direction of the connection side A.

From the two sectional views it can also be seen that a circumferential groove 141 is formed in the flange section 14, in which groove a seal 4 is arranged by which the attachable housing 1 is sealed against the wall. The depth of the groove 141 is adapted to the thickness of the seal 4 in such a way that in the mounted state the seal 4 is compressed by a defined amount, i.e., the depth of the groove 141 is slightly less than the thickness of the seal, wherein however excessive compression and thus damage to the seal 4 is prevented. The outer wall of the groove 141 also serves to protect the seal 141, protecting the seal 4 from external influences, so that a relatively soft seal 4 can be used.

From FIG. 5a, it can also be seen that the groove 141 in the flange 14 is formed so far outward in the flange section 14 that the seal 4 surrounds the holes 33 formed in the wall 3, so that the holes 33 are also sealed. This has the advantage that a user can always create a standard opening with holes 33 in the wall 3, regardless of whether an attachable housing is used that is screwed to the wall or an attachable housing 1 is used that is latched in the opening 31 with the aid of the latching tabs 15 according to the exemplary embodiment.

In order to facilitate the insertion of a contact insert 2 into the attachable housing 1, on the end faces 12 of the attachable housing 1 guide ribs 121 are formed that project into the receiving region 13 for engagement with corresponding guide grooves 241 on the end faces 24 of the contact insert 2 (cf. FIG. 2b and FIG. 3). In order to simplify the mounting of the attachable housing 1 in the opening 31 in the wall 3, a plurality of guide bolts 19 are formed on the side of the flange section 14 on the attachable housing 1, which bolts extend beyond the latching arms 15, as can be seen from FIG. 5a and FIG. 6a. As a result, the ends of the guide bolts 19 first enter corresponding holes 33 formed in the wall 3, before the latching tabs 15 enter the opening 31 in the wall 3 with their latching lugs 152. From FIG. 5a, it can also be seen that the groove 141 in the flange section 14 is arranged so far outwards that the holes 33 in the wall 3 are also enclosed by the seal 4 inserted in the groove 141, whereby the required tightness can be ensured.

FIGS. 6a and 6b show the assembly consisting of the attachable housing 1 and the inserted contact insert 2, mounted in the opening 31 in the wall 3, in one case diagonally from the connection side A (FIG. 6a) and in one case diagonally from the plug-in side S (FIG. 6b). If the contact insert 2 is inserted into the attachable housing 1 and latched in the receiving region 13, its end faces 24 prevent the latching tabs 15 from deflecting into their second position (removal position), so that the attachable housing 1 cannot be removed from the opening 31 in the wall 3 when the contact insert 2 is inserted.

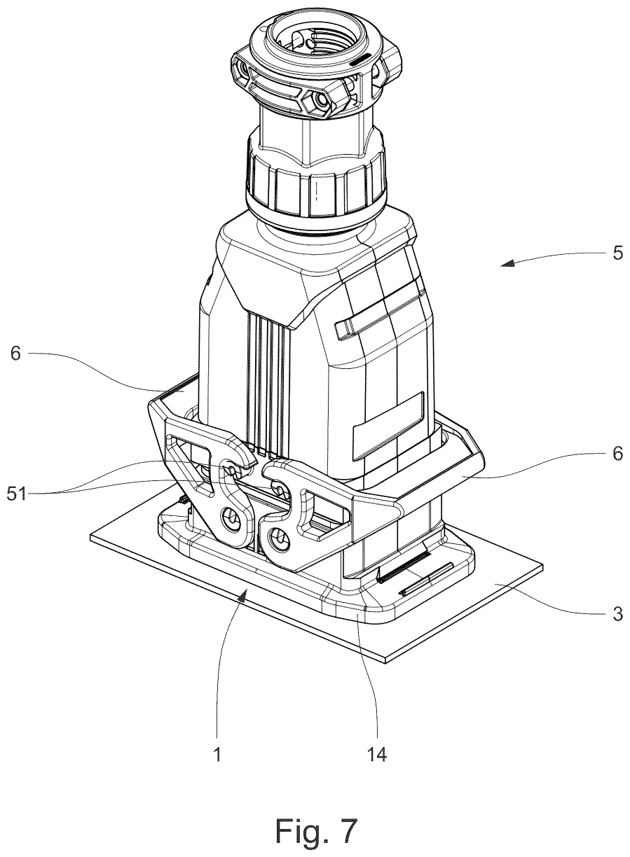

FIG. 7 shows a perspective view of an attachable housing 1 inserted into an opening 31 of the wall 3 with a mating connector 5 fastened to the attachable housing 1, to which connector a cable can be connected. The mating connector 5 is fastened by two latching brackets 6 which are pivotably mounted on the attachable housing 1 and which each engage over two corresponding latching pins 51 on the mating connector 5.

The illustrated attachable housing 1 thus enables simple, in particular tool-free, mounting in an opening 31 of a wall 3 as well as simple, likewise tool-free mounting of a contact insert 2 in the attachable housing 1, wherein the contact insert 2 can be inserted into the receiving region 13 of the attachable housing 1 both from the connection side A and from the plug-in side S.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### REFERENCE SIGNS

1. Attachable housing
11. Longitudinal side
12. End face
121. Guide rib
13. Receiving region
14. Flange section
141. Groove
15. Latching tab
151. Base region
152. Latching lug
153. Actuating portion
154. Projection
16. Latching arm
161. Base region
162. Latching lug
163. Rear side of the latching lug
17. Latching tab
171. Base region
172. Free end
18. Recess
181. Edge
19. Guide bolt
2. Contact insert
21. Insulating body
22. Contact elements
23. Longitudinal sides
24. End faces
241. Guide groove
25. Shoulder
26. Latching arm
261. Base region
262. Latching lug
263. Actuating portion
3. Wall
31. Opening
32. Edge
33. Hole
4. Seal
5. Mating plug-in connector
51. Latching pin
6. Latching bracket
A Connection side
S Plug-in side
EA Insertion direction
ES Insertion direction

1. An attachable housing for mounting on a wall having an opening, for receiving at least one contact insert, the attachable housing comprising:
two opposite longitudinal sides and two opposite end faces, which together enclose a receiving region for the at least one contact insert, the receiving region being open both to a connection side and to an opposite plug-in side, and having a circumferential flange section which, in a mounted state of the attachable housing, lies against the wall,
wherein at least one first latching element configured to latch with a corresponding first mating latching element of the at least one contact insert and at least one second latching element configured to latch with a corresponding second mating latching element of the at least one contact insert are arranged on a longitudinal side and/or an end face of the attachable housing,
wherein the at least one first latching element is configured to fix the at least one contact insert inserted into the attachable housing from the connection side, and
wherein the at least one second latching element is configured to fix the at least one contact insert inserted into the attachable housing from the plug-in side.

2. The attachable housing of claim 1, wherein the at least one first latching element has a stop for the at least one contact insert inserted into the attachable housing from the plug-in side.

3. The attachable housing of claim 1, wherein the at least one second latching element has a stop for the at least one contact insert inserted into the attachable housing from the connection side.

4. The attachable housing of claim 1, wherein the at least one first latching element comprises a resilient latching arm having a base region and a latching lug,
wherein the base region is connected to a longitudinal side or an end face of the attachable housing, and
wherein the latching arm is arranged such that the latching lug has a smaller distance from the flange section than the base region does.

5. The attachable housing of claim 4, wherein a rear side of the latching lug, which rear side runs substantially perpendicular to a longitudinal extent of the latching arm, comprises a stop for the at least one contact insert inserted into the attachable housing from the plug-in side.

6. The attachable housing of claim 1, wherein the at least one first latching element comprises a resilient latching tab having a base region and a free end,
wherein the base region is connected to a longitudinal side or an end face of the attachable housing, and
wherein the latching tab is arranged such that the base region has a smaller distance from the flange section than a free end of the latching tab does.

7. The attachable housing of claim 6, wherein the free end of the latching tab comprises a stop for the at least one contact insert inserted into the attachable housing from the plug-in side.

8. The attachable housing of claim 1, wherein the at least one second latching element comprises a recess in a longitudinal side or an end face of the attachable housing,
wherein the recess has an edge running substantially perpendicular to an insertion direction of a contact insert, which edge comprises a latching edge for a corresponding second mating latching element of the at least one contact insert.

9. The attachable housing of claim 8, wherein the edge of the recess comprises a stop for the at least one contact insert inserted into the attachable housing from the connection side.

10. The attachable housing of claim 1, further comprising:
at least two fastening elements configured to fix the attachable housing to the wall,
wherein the at least two fastening elements extend beyond the flange section.

11. The attachable housing of claim 1, wherein a groove is formed in the flange section, in which groove a seal is arranged.

12. The attachable housing of claim 1, wherein guide ribs or guide grooves configured to engage with corresponding guide grooves or ribs of the at least one contact insert are formed on the longitudinal sides or on the end faces.

13. The attachable housing of claim 10, wherein a plurality of guide bolts are formed on the attachable housing, which plurality of guide bolts extend beyond the at least two fastening elements.

14. An assembly, comprising:
the attachable housing of claim 1; and
the at least one contact insert having an insulating body in which a plurality of contact elements are arranged, the insulating body having two mutually opposite longitudinal sides and two mutually opposite end faces,
wherein at least one first mating latching element configured to latch with the corresponding first latching element of the attachable housing and at least one second mating latching element configured to latch with the corresponding second latching element of the attachable housing are formed on the insulating body,
wherein the at least one first mating latching element is configured to latch with the first latching element of the attachable housing when the at least one contact insert is inserted into the attachable housing from the connection side, and
wherein the at least one second mating latching element is configured to latch with the first latching element of the attachable housing when the at least one contact insert is inserted into the attachable housing from the plug-in side.

15. The assembly of claim 14, wherein the at least one first latching element of the attachable housing comprises a latching arm or a latching tab, and
wherein the at least one first mating latching element of the at least one contact insert comprises a shoulder on the insulating body.

16. The assembly of claim 14, wherein the at least one second latching element of the attachable housing comprises a recess, and
wherein the at least one second mating latching element of the at least one contact insert comprises a latching arm on a longitudinal side or an end face of the insulating body of the at least one contact insert.

17. The assembly of claim 16, wherein the at least one latching arm of the at least one contact insert comprises a resilient latching arm which has a base region and at least one latching lug, and
wherein the base region is connected to the insulating body.

18. The assembly of claim 17, wherein the at least one resilient latching arm of the at least one contact insert has an actuating portion configured to move the latching arm from a first position into a second position.

19. The assembly of claim 14, wherein the at least one first latching element of the attachable housing has a stop for the at least one contact insert inserted into the attachable housing from the plug-in side,
wherein the at least one shoulder on the insulating body of the at least one contact insert is formed such that the shoulder lies against the stop of the first latching element of the attachable housing when the at least one contact insert is inserted into the attachable housing from the plug-in side.

20. The assembly of claim 14, wherein the at least one second latching element of the attachable housing has a stop for the at least one contact insert inserted into the attachable housing from the connection side, and
wherein the latching arm on the insulating body of the at least one contact insert is formed such that a portion of the latching arm lies against the stop of the second latching element of the attachable housing when the at least one contact insert is inserted into the attachable housing from the connection side.
